(19) United States
(12) Patent Application Publication
(10) Pub. No.: US 2022/0068267 A1
(43) Pub. Date: Mar. 3, 2022

(54) METHOD AND APPARATUS FOR RECOGNIZING SPEECH, ELECTRONIC DEVICE AND STORAGE MEDIUM

(71) Applicant: BEIJING BAIDU NETCOM SCIENCE TECHNOLOGY CO., LTD., Beijing (CN)

(72) Inventors: Zhen Wu, Beijing (CN); Maoren Zhou, Beijing (CN); Zhijian Wang, Beijing (CN); Yafeng Cui, Beijing (CN); Yufang Wu, Beijing (CN); Qin Qu, Beijing (CN); Bing Liu, Beijing (CN); Jiaxiang Ge, Beijing (CN)

(73) Assignee: BEIJING BAIDU NETCOM SCIENCE TECHNOLOGY CO., LTD., Beijing (CN)

(21) Appl. No.: 17/451,033

(22) Filed: Oct. 15, 2021

(30) Foreign Application Priority Data
Nov. 24, 2020 (CN) 202011333455.7

(51) Int. Cl. G10L 15/18; G10L 15/08; G10L 15/02

(52) U.S. Cl. CPC G10L 15/1815; G10L 15/02; G10L 15/08

(57) ABSTRACT

The disclosure provides a method and an apparatus for recognizing a speech, an electronic device and a storage medium. Based on obtaining target speech information, state information of an application corresponding to the target speech information and contextual information are obtained. Semantic completeness of the target speech information is obtained based on the state information and the contextual information. A monitoring duration corresponding to the semantic completeness is obtained, and it is monitored whether there is speech information within the monitoring duration. Speech recognition is performed on the target speech information based on no speech information being monitored within the monitoring duration.

### CROSS REFERENCE TO RELATED APPLICATION(S)

This application claims priority and benefits to Chinese Application No. 202011333455.7, filed on Nov. 24, 2020, the entire content of which is incorporated herein by reference.

### TECHNICAL FIELD

The disclosure relates to a field of artificial intelligence technologies, a field of deep learning technologies and a field of speech technologies, and more particularly to a method and an apparatus for recognizing a speech, an electronic device, and a storage medium.

### BACKGROUND

With the development of artificial intelligence technologies, smart home products, such as a smart speaker and a smart robot, are developed. Operations of related products can be controlled by the user based on speech inputs. For example, the user can say “opening the music” to the smart speaker, and the smart speaker executes an operation of opening a music application.

### SUMMARY

In one embodiment, a method for recognizing a speech is provided. The method includes: based on obtained target speech information, obtaining state information of an application corresponding to the target speech information and contextual information; obtaining a semantic completeness of the target speech information based on the state information and the contextual information; determining a monitoring duration corresponding to the semantic completeness and monitoring whether there is speech information within the monitoring duration; and performing speech recognition on the target speech information when no speech information is detected within the monitoring duration.

In one embodiment, an electronic device is provided. The electronic device includes at least one processor and a memory communicatively coupled to the at least one processor. The memory stores instructions executable by the at least one processor. When the instructions are executed by the at least one processor, the at least one processor is caused to execute a method for recognizing a speech according to the first aspect of the disclosure.

In one embodiment, a non-transitory computer-readable storage medium storing computer instructions is provided. The computer instructions are configured to cause a computer to execute a method for recognizing a speech according to the first aspect of the disclosure.

It is to be understood that the content described in this section is not intended to identify key or important features of the embodiments of the disclosure, nor is it intended to limit the scope of the disclosure. Additional features of the disclosure will be easily understood based on the following description.

### BRIEF DESCRIPTION OF THE DRAWINGS

The drawings are used to better understand the solution and do not constitute a limitation to the disclosure, in which:

FIG. 1 is a flowchart illustrating a method for recognizing a speech according to some embodiments of the disclosure.

FIG. 2 is a schematic diagram illustrating a speech recognition scene according to some embodiment of the disclosure.

FIG. 3 is a schematic diagram illustrating a speech recognition scene according to some embodiments of the disclosure.

FIG. 4 is a schematic diagram illustrating a speech recognition scene according to some embodiments of the disclosure.

FIG. 5 is a schematic diagram illustrating a speech recognition scene according to some embodiments of the disclosure.

FIG. 6 is a flowchart illustrating a method for recognizing a speech according to some embodiments of the disclosure.

FIG. 7 is a flowchart illustrating a method for recognizing a speech according to some embodiments of the disclosure.

FIG. 8 is a schematic diagram illustrating a speech recognition scene according to some embodiments of the disclosure.

FIG. 9 is a flowchart illustrating a method for recognizing a speech according to some embodiments of the disclosure.

FIG. 10 is a block diagram illustrating an apparatus for recognizing a speech according to some embodiments of the disclosure.

FIG. 11 is a block diagram illustrating an apparatus for recognizing a speech according to some embodiments of the disclosure.

FIG. 12 is a block diagram illustrating an apparatus for recognizing a speech according to some embodiments of the disclosure.

FIG. 13 is a block diagram illustrating an electronic device for implementing a method for recognizing a speech according to embodiments of the disclosure.

### DETAILED DESCRIPTION

The following describes the exemplary embodiments of the disclosure with reference to the accompanying drawings, which includes various details of the embodiments of the disclosure to facilitate understanding, which shall be considered merely exemplary. Therefore, those of ordinary skill in the art should recognize that various changes and modifications can be made to the embodiments described herein without departing from the scope and spirit of the disclosure. For clarity and conciseness, descriptions of well-known functions and structures are omitted in the following description.

In related arts, in order to obtain an entirety of speech information, an end point detection can be performed on the speech information. That is, a pause duration of the acquired speech information is detected, where the pause duration may be understood as a silent duration or a mute duration. When the pause duration is equal to or greater than a certain value, it is considered that the entirety of the speech information is received. This way of determining whether the entirety of the speech information is obtained is restrictive, which may lead to acquiring incomplete speech information and low accuracy of speech recognition.

That is, the end point of the speech information is detected by determining whether a silent duration is equal to or greater than a certain value, resulting in a technical problem that the obtained speech information is incomplete. The disclosure provides a technical solution for flexibly determining the silent duration based on the completeness of the speech information. A semantic completeness of obtained speech information is determined based on multi-dimensional parameters and the detection duration of detecting the speech information is flexibly detected based on the semantic completeness to avoid truncation of the speech information and improve accuracy of the speech recognition.

The method and the apparatus for recognizing a speech, an electronic device, and a storage medium according to embodiments of the disclosure will be described below. An execution body of the method for recognizing a speech according to embodiments of the disclosure may be an electronic device with a speech recognition function. The electronic device includes but is not limited to a smart speaker, a smart phone, and a smart robot.

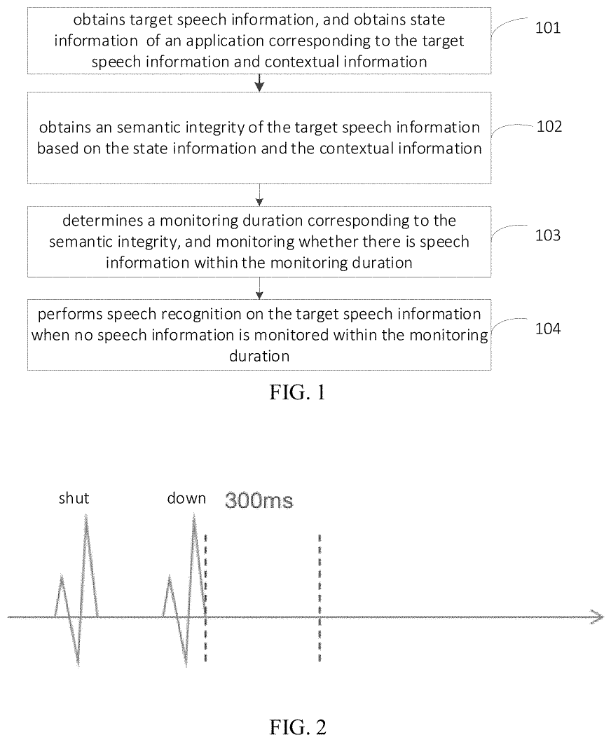

FIG. 1 is a flowchart illustrating a method for recognizing a speech according to some embodiments of the disclosure. As illustrated in FIG. 1, the method includes the following.

At block 101, based on obtained target speech information, state information of an application corresponding to the target speech information and contextual information are obtained.

After detecting that there is the target speech information, in order to judge the target speech information, the state information of the application corresponding to the target speech and the contextual information are acquired.

The state information of the application includes but is not limited to the state information of a currently running application. For example, for a smart speaker, the state information of the application includes current state information (pausing or playing) of a music playing application. The contextual information includes but is not limited to the speech information sent to the smart device in a previous round or multiple rounds of conversations, response information to the speech information from the smart device in the previous round or multiple rounds of conversations, and a time-based correspondence between the speech information and the response information. For example, for the smart speaker, the contextual information is a last speech message, e.g., “opening the music”, and a last response message to the speech message, e.g., “do you want to play this song”.

In an actual execution process, after detecting that there is the speech information, if the silent duration (or mute duration) of the speech information is equal to or greater than a certain value, it is considered that the target speech information is obtained. The value may be an empirical small value to ensure that the obtained target speech information is what the user desires to input by temporarily stopping inputting the speech information.

At block 102, a semantic completeness of the target speech information is obtained based on the state information and the contextual information.

Both the state information and the contextual information are used to determine whether the speech is complete. As an example, when the target speech information is “playing”, if the state information is a pause state of the music, it is obvious that the target speech information is a complete semantic expression. As another example, when the contextual information is “this song is awful, I want to listen to another song”, the target speech information “playing” is an incomplete semantic expression.

Therefore, the semantic completeness of the target speech information is calculated in combination with the multi-dimensional information, such as the state information and the contextual information.

At block 103, a monitoring duration corresponding to the semantic completeness is determined, and it is monitored where there is speech information within the monitoring duration.

The monitoring duration may be understood as a waiting duration to continue monitoring the speech information, which can be also understood as the mute duration for waiting the user to subsequently input the speech information. As illustrated in FIG. 2, when the obtained target speech information is “shutting down”, in order to avoid that the obtained target speech information is incomplete, the process still waits for 300 ms. In this case, the 300 ms is understood as the monitoring duration.

The higher the semantic completeness, the higher the possibility that the obtained target speech information is complete. In this case, in order to improve the response speed, the monitoring duration need to be shortened or even 0. Instead, when the semantic completeness is low, the expression represented by the target speech information is not complete. In this case, in order to ensure that the obtained speech information is complete, the monitoring duration is prolonged. Therefore, the monitoring duration corresponding to the semantic completeness is determined, and it is determined whether there is the speech information during the monitoring duration.

It is to be noted that in different application scenes, the methods for determining the monitoring duration corresponding to the semantic completeness are different. Examples are provided as follows.

### Example 1

A correspondence between the semantic completeness and the monitoring duration is preset. Therefore, the monitoring duration corresponding to the semantic completeness is obtained by querying the preset correspondence.

### Example 2

A reference semantic completeness corresponding to a reference value of the monitoring duration is preset. The reference value of the monitoring duration may be understood as a preset default monitoring duration. A semantic difference between a current semantic completeness of the target speech information and the reference semantic completeness is calculated. An adjustment value of the monitoring duration is determined based on the semantic difference. The semantic difference is inversely proportional to the adjustment value of the monitoring duration. A sum of the adjustment value and the reference value of the monitoring duration is calculated as the monitoring duration.

At block 104, the speech recognition is performed on the target speech information when no speech information is detected within the monitoring duration.

When it is detected that no speech information is monitored within the monitoring duration, it indicates that the user has finished inputting the speech information and the speech recognition is performed based on the target speech information. For example, the target speech information is converted into text information, keywords are extracted from the text information, and a control processing is performed based on a control instruction matching the keywords.

When it is monitored that there is the speech information within the monitoring duration, the detected speech information and the target speech information are determined as new target speech information. The state information of an application corresponding to the new target speech information and the contextual information of the new target speech information are obtained to determine the semantic completeness of the new target speech information, thereby achieving streaming determination.

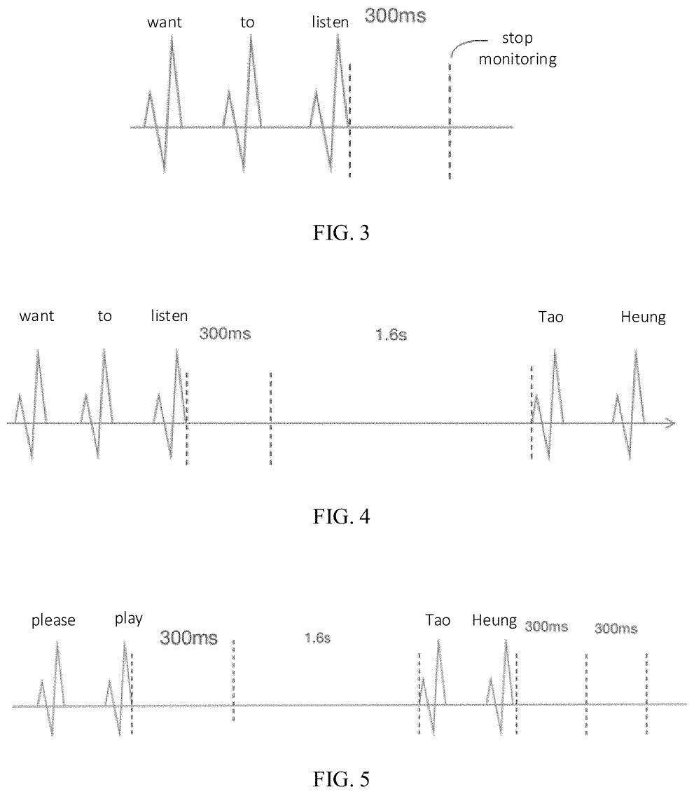

Therefore, the monitoring duration matching the semantic completeness of the target speech information may be determined, which balances the efficiency of the speech recognition and the completeness of the target speech information. For example, as illustrated in FIG. 3, when the target speech information is “I want to listen”, if it is considered that the obtaining of the target speech information is finished directly after 300 ms (which is set by default), it is possible that the corresponding control instruction cannot be recognized based on the speech information “I want to listen”. In view of this, with the method for recognizing a speech according to embodiments of the disclosure, as illustrated in FIG. 4, based on the completeness of the target speech information, after the 300 ms, the mute duration continues to last for 1.6 seconds, and the speech information “Tao Heung” is detected during this duration, such that the complete speech information can be obtained and the operation of playing “Tao Heung” is performed for the user.

Certainly, within the monitoring duration after obtaining the target speech information “playing”, if it is monitored that there is the speech information “Tao Heung”, the semantic completeness of “playing Tao Heung” is determined based on the state information and the contextual information. If the completeness is not high, as illustrated in FIG. 5, the monitoring duration after “Tao Heung” is determined to achieve the streaming determination.

In conclusion, with the method for recognizing a speech according to embodiments of the disclosure, in response to the obtained target speech information, the state information of the application corresponding to the target speech information and the contextual information are obtained, and the semantic completeness of the target speech information is calculated based on the state information and the contextual information. The monitoring duration corresponding to the semantic completeness is determined, and it is monitored whether there is the speech information during the monitoring duration. If it is monitored that there is no speech information within the monitoring duration, the speech recognition is performed based on the target speech information. As a result, the semantic completeness of the obtained speech information is determined based on the multi-dimensional parameters, and the duration of detecting the speech information may be flexibly adjusted based on the semantic completeness, thereby avoiding truncation of the speech information, and improving the accuracy of the speech recognition.

Based on the above embodiments, in different application scenes, the methods for calculating the semantic completeness of the target speech information based on the state information and the contextual information are different. Examples are described as follows.

### Example 1

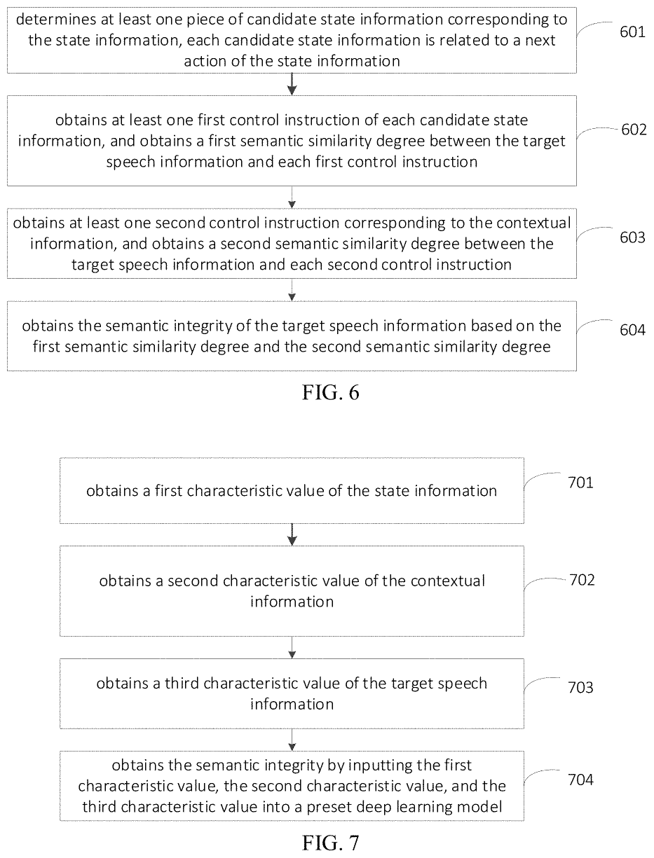

As illustrated in FIG. 6, obtaining the semantic completeness of the target speech information based on the state information and the contextual information includes the following.

At block 601, at least one piece of candidate state information corresponding to the state information is determined. Each candidate state information is the state information of a next candidate action after a current state information.

Based on a running logic of the application, the state information of one or more next candidate actions of the current state information can be determined. For example, when the state information of the application is “closing or shutting down”, the state information of the next executable candidate action may be “powering on”. For example, when the state information of the application is “playing the music”, the state information of the next executable candidate action may be “pausing”, “replaying”, “turning up the sound” and “fast forwarding”.

Therefore, in some embodiments, the at least one piece of candidate state information corresponding to the state information is determined based on the running logic of the application corresponding to the state information. Each piece of candidate state information is the state information of a next candidate action of the state information. The running logic may be preset, which may include a node sequence corresponding to the state information between actions.

At block 602, at least one executable first control instruction of each candidate state information is obtained, and a first semantic similarity degree between the target speech information and each first control instruction is calculated.

In some embodiments, the at least one executable first control instruction of each candidate state information can be obtained by querying a preset correspondence, where the preset correspondence includes a correspondence between the candidate state information and the first control instructions. For example, when the candidate state information is “playing the music”, the corresponding first control instruction may include “playing the music”. When the state information is “pausing”, the corresponding first control instruction may include “pausing”, “stopping”, and “being quiet for a while”.

The first semantic similarity degree between the target speech information and each first control instruction is calculated to determine whether the target speech information belongs to the first control instruction.

At block 603, at least one second control instruction corresponding to the contextual information is obtained and a second semantic similarity degree between the target speech information and each second control instruction is obtained.

The second control instruction corresponds to the contextual information. When the contextual information includes a response message “do you want to play music” sent back from the smart speaker, the corresponding second control instruction may be “playing” or “no”.

In some embodiments, a deep learning model may be obtained in advance through training and learning a large amount of sample data. The input of the deep learning model is the contextual information and the output is the second control instruction. Therefore, the corresponding second control instruction may be obtained based on the deep learning model.

It may be unreliable to determine the semantic completeness of the target speech information only based on the first semantic similarity. Therefore, the at least one second control instruction corresponding to the contextual information is further determined and the second semantic similarity degree between the target speech information and each second control instruction is calculated.

At block 604, the semantic completeness of the target speech information is obtained based on the first semantic similarity degree and the second semantic similarity degree.

The semantic completeness of the target speech information is calculated based on the first semantic similarity degree and the second semantic similarity degree.

In some examples, a first target control instruction is obtained, where a first semantic similarity degree of the first target control instruction is greater than a first threshold. A second target control instruction is obtained, where a second semantic similarity degree of the second target control instruction is greater than a second threshold. The semantic similarity degree between the first target control instruction and the second target control instruction is determined to obtain the semantic completeness. That is, the semantic similarity degree between the first target control instruction and the second target control instruction is directly determined as the semantic completeness of the target speech information.

If no first control instruction is obtained but the second control information is obtained, a first difference between the first threshold and the first semantic similarity degree is determined, a first ratio of the first difference to the first threshold is determined, and a first product value of the second semantic similarity degree to the first ratio is obtained to obtain the semantic completeness. That is, the effect of second semantic similarity degree is weakened based on the difference between the first semantic similarity degree and the first threshold, to avoid that the first control instruction belongs to the candidate state information but not conform to the contextual information.

If no second control instruction is obtained but the first control instruction is obtained, a second difference between the second threshold and the second semantic similarity degree is determined, a second ratio of the second difference to the second threshold is determined, and a second product value of the first semantic similarity degree and the second ratio is obtained, to obtain the semantic completeness. That is, the effect of the first semantic similarity degree is weakened based on the difference between the second semantic similarity degree and the second threshold, to avoid that the first control instruction conforms to the contextual information but not belong to the candidate state information.

If neither the second control information nor the first control instruction is obtained, a third difference between the first semantic similarity degree and the second semantic similarity degree is determined, and an absolute value of the third difference is obtained to obtain the semantics completion. In this case, the value of the third difference is usually small, which means that the semantics of the target speech information is not complete.

The first semantic similarity degree and the second semantic similarity degree are both high, indicating that the target speech information is more likely to be a complete semantic expression. However, when the first semantic similarity degree is high but the second semantic similarity degree is not high, or the first semantic similarity degree is not high but the second semantic similarity degree is high, it indicates that the target speech information is the incomplete semantic expression. Therefore, determining the semantic completeness based on both the first semantic similarity degree and the second semantic similarity degree improves the reliability of the determination.

### Example 2

As illustrated in FIG. 7, obtaining the semantic completeness of the target speech information based on the first semantic similarity degree and the second semantic similarity degree includes the following.

At block 701, a first characteristic value of the state information is obtained.

At block 702, a second characteristic of the contextual information is obtained.

At block 703, a third characteristic value of the target speech information is obtained.

At block 704, the semantic completeness is obtained by inputting the first characteristic value, the second characteristic value, and the third characteristic value into a preset deep learning model.

The preset deep learning model learns in advance the correspondence between the first characteristic value, the second characteristic value, the third characteristic value and the semantic completeness in advance.

The preset deep learning model includes but is not limited to a DNN model or an LSTM model. In some examples, the first characteristic value, the second characteristic value, and the third characteristic value may be normalized by the preset deep learning model, and the normalized first characteristic value, the normalized second characteristic value, and the normalized third characteristic value are input into the preset deep learning model.

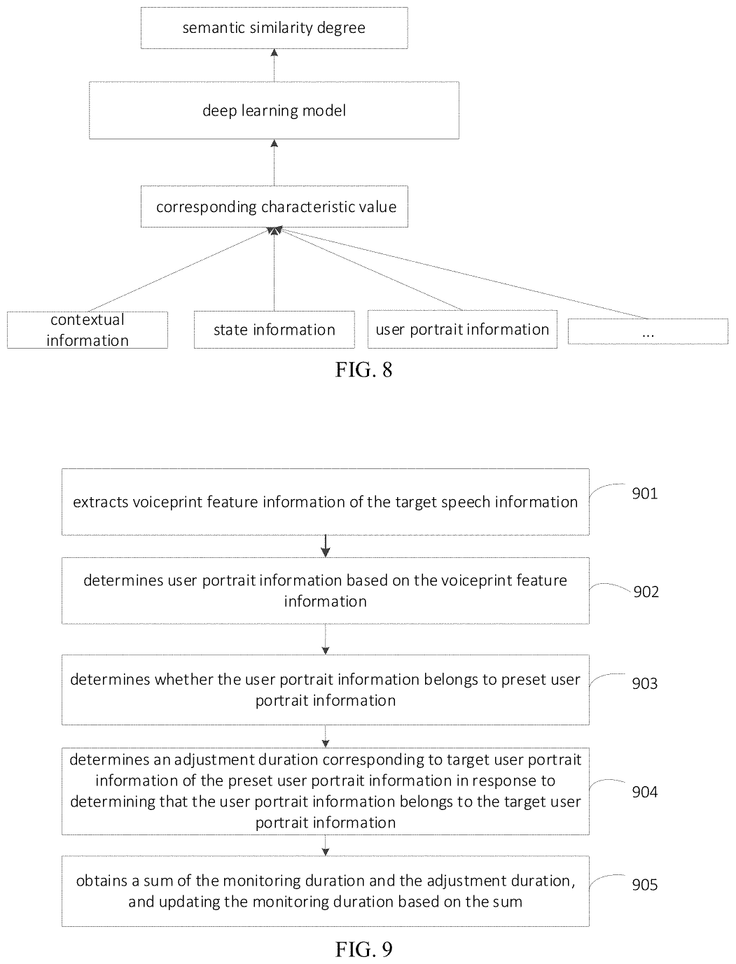

A self semantic completeness of the target speech information may be extracted. The self semantic completeness may be obtained by analyzing the part of speech. As illustrated in FIG. 8, the self semantic completeness, the first characteristic value, the second characteristic value, and the third characteristic value are input to the corresponding deep learning model.

It is taken into account that the user may provide the expression information in a slow speed, such as a child with a relatively slow speaking rate, a people having language barriers, or a new user who is not familiar with the smart device. Therefore, if the user is a newly registered user and is a child, when it is determined that this user is not proficient in using the device based on historical behavior analysis, and the historical behaviors show many hesitated expressions, as well as the device is not in a state of asking whether to play or pause, after detecting that the user intermediate result is “playing”, it is very likely that the expression “playing” is incomplete. In this case, the mute duration needs to be prolonged to wait for the user to finish saying.

Therefore, the semantic completeness can be determined in combination with user portrait information. The user portrait information includes the user's age, the user's identity, and the user registration duration.

As illustrated in FIG. 9, before determining the monitoring duration corresponding to the semantic completeness, the method includes the following.

At block 901, voiceprint feature information of the target speech information is extracted.

The operation of extracting the voiceprint feature information may be implemented with existing technologies, which is not repeated here. The voiceprint feature information may include timbre and audio.

At block 902, user portrait information is determined based on the voiceprint feature information.

The correspondence between the user portrait information and the voiceprint feature information is stored in advance. The user portrait information corresponding to the voiceprint feature information is determined based on the correspondence.

At block 903, it is determined whether the user portrait information belongs to preset user portrait information.

It is determined whether the user portrait information belongs to the preset user portrait information which is the information related to a user who provides hesitated expression or speaks slowly.

At block 904, an adjustment duration corresponding to target user portrait information is determined in response to determining that the user portrait information belongs to the target user portrait information of the preset user portrait information.

If the user portrait information belongs to the target portrait information in the preset user portrait information, the adjustment duration corresponding to the target user portrait information is determined.

The adjustment duration corresponding to the target user portrait information can be determined by pretraining the deep learning model or based on a correspondence.

At block 905, a sum of the monitoring duration and the adjustment duration is determined, and the monitoring duration is updated based on the sum.

The sum of the monitoring duration and the adjustment duration is calculated, and the monitoring duration is updated based on the sum, where the adjustment duration may be a positive value or a negative value.

If the target speech information is a complete semantic expression based on the self semantic detection of the target speech information, it is possible that the determination of the semantic completeness of the target speech information based on the state information and the contextual information is not performed. Rather, the monitoring process is directly intercepted.

Therefore, in some embodiments of the disclosure, before determining the semantic completeness of the target speech information based on the state information and the contextual information, the method further includes determining whether the target speech information belongs to the preset complete semantic information corresponding to the state information and the contextual information. When the target speech information belongs to the preset complete semantic information corresponding to the state information and the contextual information, the target semantic information is directly determined as the speech information to be recognized.

In conclusion, with the method for recognizing a speech according to embodiments of the disclosure, depending on the scene, different methods are flexibly adopted to calculate the semantic completeness of the target speech information based on the state information and the contextual information, which helps to improve the accuracy of the speech recognition.

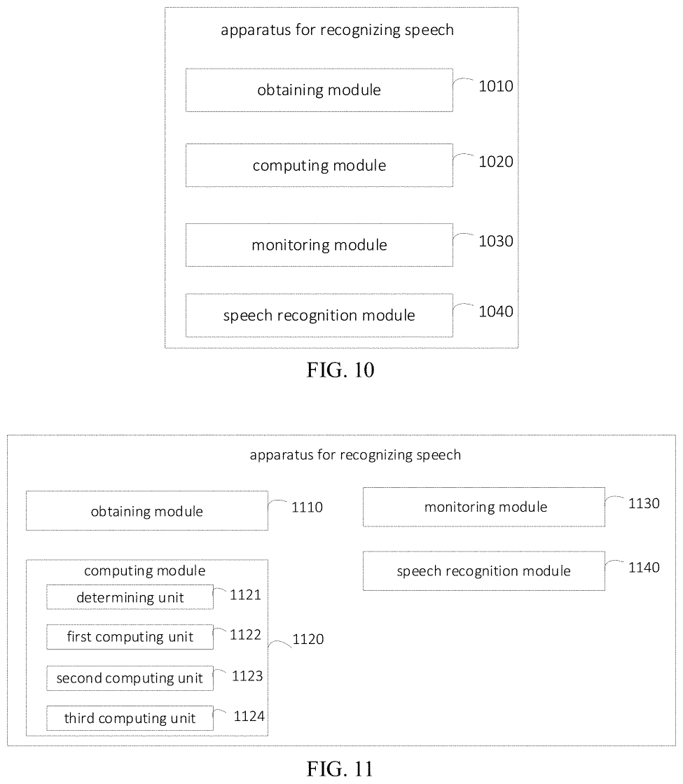

Embodiments of the disclosure further provide an apparatus for recognizing a speech. FIG. 10 is a schematic diagram illustrating an apparatus for recognizing a speech according to embodiments of the disclosure. As illustrated in FIG. 10, the apparatus for recognizing a speech includes: an obtaining module 1010, a calculating module 1020, a monitoring module 1030 and a speech recognition module 1040.

The obtaining module 1010 is configured to, based on obtained target speech information, obtain state information of an application corresponding to the target speech information and contextual information.

The calculating module 1020 is configured to obtain a semantic completeness of the target speech information based on the state information and the contextual information.

The monitoring module 1030 is configured to determine a monitoring duration corresponding to the semantic completeness, and monitor whether there is speech information within the monitoring duration.

The speech recognition module 1040 is configured to perform speech recognition on the target speech information when no speech information is detected within the monitoring duration.

In some embodiments, the monitoring module 1030 is further configured to obtain the monitoring duration based on the semantic completeness by querying a preset correspondence.

It is to be noted that the foregoing explanation of the method for recognizing a speech is also applicable to the apparatus for recognizing a speech according to embodiments of the disclosure, and the implementation principle is similar, which is not repeated here.

In conclusion, with the apparatus for recognizing a speech according to embodiments of the disclosure, the state information of the application corresponding to the target speech information and the contextual information are obtained based on the acquired target speech information. The semantic completeness of the target speech information is obtained based on the state information and the contextual information. The monitoring duration corresponding to the semantic completeness is determined, and it is determined whether there is the speech information within the monitoring duration. When there is no speech information within the monitoring duration, the speech recognition is performed based on the target speech information. Therefore, the semantic completeness of the acquired speech information is determined based on multi-dimensional parameters, and the detection duration of detecting whether there is the speech information may be flexibly adjusted based on the semantic completeness, thereby avoiding truncation of the speech information, and improving accuracy of the speech recognition.

In some embodiments, as illustrated in FIG. 11, the apparatus for recognizing a speech includes: an obtaining module 1110, a calculating module 1120, a monitoring module 1130, and a speech recognition module 1140. The obtaining module 1110, the calculating module 1120, the monitoring module 1130, and the speech recognition module 1140 are the same as the obtaining module 1010, the calculating module 1020, the monitoring module 1030 and the speech recognition module 1040 in FIG. 10 respectively, which are not repeated here. The calculating module 1120 includes a determining unit 1121, a first calculating unit 1122, a second calculating unit 1123 and a third calculating unit 1124.

The determining unit 1121 is configured to determine at least one piece of candidate state information corresponding to the state information. Each candidate state information is state information of a next action of current state information.

The first calculating unit 1122 is configured to obtain at least one executable first control instruction of each candidate state information, and obtain a first semantic similarity degree between the target speech information and each first control instruction.

The second calculating unit 1123 is configured to obtain at least one second control instruction corresponding to the contextual information, and obtain a second semantic similarity degree between the target speech information and each second control instruction.

The third calculating unit 1124 is configured to obtain the semantic completeness of the target speech information based on the first semantic similarity degree and the second semantic similarity degree.

In some embodiments, the third calculating unit 1124 is further configured to obtain a first target control instruction that the first semantic similarity degree of the first target control instruction is greater than a first threshold; obtain a second target control instruction that the second semantic similarity degree of the second target control instruction is greater than a second threshold; and obtain the semantic completeness based on a semantic similarity between the first target control instruction and the second target control instruction.

In some embodiments, the third calculating unit 1124 is further configured to obtain a first difference between the first threshold and the first semantic similarity degree, when no first control instruction is acquired and the second control information is obtained; obtain a first ratio of the first difference to the first threshold; and obtain the semantic completeness based on a first product value of the second semantic similarity degree and the first ratio.

In some embodiments, the third calculating unit 1124 is further configured to obtain a second difference between the second threshold and the second semantic similarity degree, when no second control instruction is acquired and the first control instruction is acquired; obtain a second ratio of the second difference to the second threshold; and obtain the semantic completeness based on a second product value of the first semantic similarity degree and the second ratio.

In some embodiments, the third calculating unit 1124 is further configured to obtain a third difference between the first semantic similarity degree and the second semantic similarity degree, when no second control instruction is acquired and no first control instruction is acquired; and obtain the semantic completeness based on an absolute value of the third difference.

In some embodiments, the calculating module 1120 is further configured to obtain a first characteristic value of the state information; obtain a second characteristic value of the contextual information; obtain a third characteristic value of the target speech information; and obtain the semantic completeness by inputting the first characteristic value, the second characteristic value, and the third characteristic value into a preset deep learning model.

The preset deep learning model learns in advance a preset correspondence between the first characteristic value, the second characteristic value, the third characteristic value, and the semantic completeness.

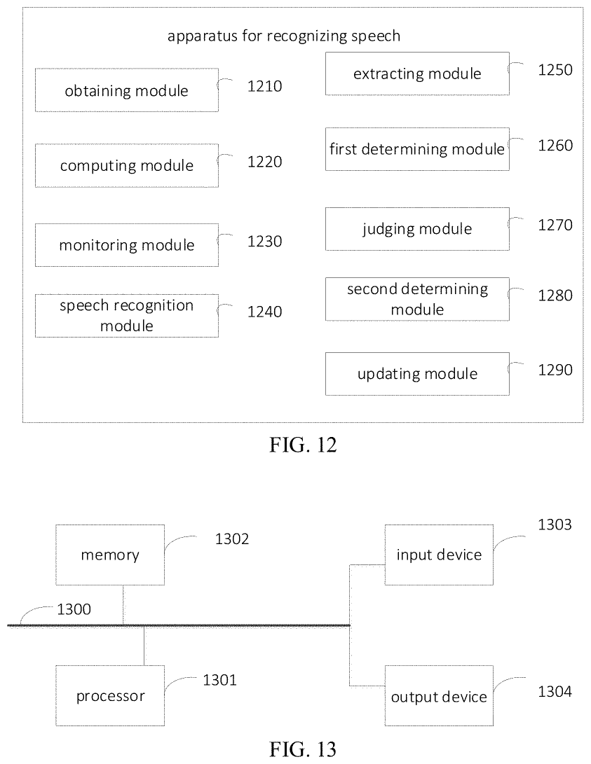

In some embodiments, as illustrated in FIG. 12, the apparatus for recognizing a speech includes: an obtaining module 1210, a calculating module 1220, a monitoring module 1230, a speech recognition module 1240, an extracting module 1250, a first determining module 1260, a judging module 1270, a second determining module 1280, and an updating module 1290. The obtaining module 1210, the calculating module 1220, the monitoring module 1230, and the speech recognition module 1240 are the same as the obtaining module 1010, the calculating module 1020, the monitoring module 1030, and the speech recognition module 1040 in FIG. 10 respectively, which is not repeated here.

The extracting module 1250 is configured to extract voiceprint feature information of the target speech information.

The first determining module 1260 is configured to determine user portrait information based on the voiceprint feature information.

The judging module 1270 is configured to determine whether the user portrait information belongs to preset user portrait information.

The second determining module 1280 is configured to determine an adjustment duration corresponding to target user portrait information in response to determining that the user portrait information belongs to the target user portrait information.

The updating module 1290 is configured to obtain a sum of the monitoring duration and the adjustment duration, and update the monitoring duration based on the sum.

It is to be noted that the foregoing explanation of the method for recognizing a speech is also applicable to the apparatus for recognizing a speech according to embodiments of the disclosure, and the implementation principle is similar, which is not repeated here.

In conclusion, with the apparatus for recognizing a speech according to embodiments of the disclosure, different methods to calculate the semantic completeness of the target speech information based on the state information and the contextual information may be flexibly used depending on different scenes, which can improve the accuracy of the speech recognition.

According to embodiments of the disclosure, the disclosure further provides an electronic device and a readable storage medium.

FIG. 13 is a block diagram of an electronic device configured to implement the method for recognizing a speech according to embodiments of the disclosure. Electronic devices are intended to represent various forms of digital computers, such as laptop computers, desktop computers, workbenches, personal digital assistants, servers, blade servers, mainframe computers, and other suitable computers. Electronic devices may also represent various forms of mobile devices, such as personal digital processing, cellular phones, smart phones, wearable devices, and other similar computing devices. The components shown here, their connections and relations, and their functions are merely examples, and are not intended to limit the implementation of the disclosure described and/or required herein.

As illustrated in FIG. 13, the electronic device includes: one or more processors 1301, a memory 1302, and interfaces for connecting various components, including a high-speed interface and a low-speed interface. The various components are interconnected using different buses and can be mounted on a common mainboard or otherwise installed as required. The processor may process instructions executed within the electronic device, including instructions stored in or on the memory to display graphical information of the GUI on an external input/output device such as a display device coupled to the interface. In other embodiments, a plurality of processors and/or buses can be used with a plurality of memories and processors, if desired. Similarly, a plurality of electronic devices can be connected, each providing some of the necessary operations (for example, as a server array, a group of blade servers, or a multiprocessor system). A processor 1301 is taken as an example in FIG. 13.

The memory 1302 is a non-transitory computer-readable storage medium according to the disclosure. The memory stores instructions executable by at least one processor, so that the at least one processor executes the method according to the disclosure. The non-transitory computer-readable storage medium of the disclosure stores computer instructions, which are used to cause a computer to execute the method according to the disclosure.

As a non-transitory computer-readable storage medium, the memory 1302 is configured to store non-transitory software programs, non-transitory computer executable programs and modules, such as program instructions/modules corresponding to the method in the embodiments of the disclosure. The processor 1301 executes various functional applications and data processing of the electronic device by running non-transitory software programs, instructions, and modules stored in the memory 1302, that is, implementing the method in the foregoing method embodiments.

The memory 1302 may include a storage program area and a storage data area, where the storage program area may store an operating system and application programs required for at least one function. The storage data area may store data created according to the use of the electronic device for implementing the method. In addition, the memory 1302 may include a high-speed random access memory, and a non-transitory memory, such as at least one magnetic disk storage device, a flash memory device, or other non-transitory solid-state storage device. In some embodiments, the memory 1302 may optionally include a memory remotely disposed with respect to the processor 1301, and these remote memories may be connected to the electronic device for implementing the method through a network. Examples of the above network include, but are not limited to, the Internet, an intranet, a local area network, a mobile communication network, and combinations thereof.

The electronic device used to implement the method may further include: an input device 1303 and an output device 1304. The processor 1301, the memory 1302, the input device 1303, and the output device 1304 may be connected through a bus or in other manners. In FIG. 13, the connection through the bus is taken as an example.

The input device 1303 may receive inputted numeric or character information, and generate key signal inputs related to user settings and function control of an electronic device for implementing the method, such as a touch screen, a keypad, a mouse, a trackpad, a touchpad, an indication rod, one or more mouse buttons, trackballs, joysticks and other input devices. The output device 1304 may include a display device, an auxiliary lighting device (for example, an LED), a haptic feedback device (for example, a vibration motor), and the like. The display device may include, but is not limited to, a liquid crystal display (LCD), a light emitting diode (LED) display, and a plasma display. For example, the display device may be a touch screen.

Various embodiments of the systems and technologies described herein may be implemented in digital electronic circuit systems, integrated circuit systems, application specific integrated circuits (ASICs), computer hardware, firmware, software, and/or combinations thereof. These various embodiments may be implemented in one or more computer programs. That is, the disclosure provides a computer program that, when executed by a processor, the method for speech recognition described in the above embodiments is implemented. The one or more computer programs may be executed and/or interpreted on a programmable system including at least one programmable processor. The programmable processor may be a dedicated or general programmable processor, which is configured to receive data and instructions from a storage system, at least one input device and at least one output device, and to transmit the data and instructions to the storage system, the at least one input device, and the at least one output device.

These computing programs (also known as programs, software, software applications, or code) include machine instructions of a programmable processor and may utilize high-level processes and/or object-oriented programming languages, and/or assembly/machine languages to implement these calculation procedures. As used herein, the terms “machine-readable medium” and “computer-readable medium” refer to any computer program product, device, and/or device used to provide machine instructions and/or data to a programmable processor (for example, magnetic disks, optical disks, memories, programmable logic devices (PLDs), including machine-readable media that receive machine instructions as machine-readable signals. The term “machine-readable signal” refers to any signal used to provide machine instructions and/or data to a programmable processor.

In order to provide interaction with a user, the systems and techniques described herein may be implemented on a computer having a display device (e.g., a Cathode Ray Tube (CRT) or a Liquid Crystal Display (LCD) monitor for displaying information to a user); and a keyboard and pointing device (such as a mouse or trackball) through which the user can provide input to the computer. Other kinds of devices may also be used to provide interaction with the user. For example, the feedback provided to the user may be any form of sensory feedback (e.g., visual feedback, auditory feedback, or haptic feedback), and the input from the user may be received in any form (including acoustic input, voice input, or tactile input).

The systems and technologies described herein can be implemented in a computing system that includes background components (for example, a data server), or a computing system that includes middleware components (for example, an application server), or a computing system that includes front-end components (for example, a user computer with a graphical user interface or a web browser, through which the user can interact with the implementation of the systems and technologies described herein), or include such background components, intermediate computing components, or any combination of front-end components. The components of the system may be interconnected by any form or medium of digital data communication (e.g., a communication network). Examples of communication networks include: local area network (LAN), wide area network (WAN), the Internet, and a Block-chain services network.

The computer system may include a client and a server. The client and server are generally remote from each other and interacting through a communication network. The client-server relation is generated by computer programs running on the respective computers and having a client-server relation with each other. The server may be a cloud server, also known as a cloud computing server or a cloud host, which is a host product in the cloud computing service system, to solve defects such as difficult management and weak business scalability in the traditional physical host and Virtual Private Server (VPS) service. The server may also be a server of a distributed system, or a server combined with a block-chain.

It is to be understood that the various forms of processes shown above can be used to reorder, add or delete steps. For example, the steps described in the disclosure could be performed in parallel, sequentially, or in a different order, as long as the desired result of the technical solution disclosed in the disclosure is achieved, which is not limited herein.

The above specific embodiments do not constitute a limitation on the protection scope of the disclosure. Those skilled in the art should understand that various modifications, combinations, sub-combinations and substitutions can be made according to design requirements and other factors. Any modification, equivalent replacement and improvement made within the spirit and principle of the disclosure shall be included in the protection scope of the disclosure.

What is claimed is:

1. A method for recognizing a speech, comprising:
obtaining state information of an application corresponding to target speech information and contextual information, based on obtaining the target speech information;
obtaining a semantic completeness of the target speech information based on the state information and the contextual information;
determining a monitoring duration corresponding to the semantic completeness, and monitoring whether there is speech information within the monitoring duration; and
performing speech recognition on the target speech information based on no speech information being monitored within the monitoring duration.

2. The method of claim 1, wherein obtaining the semantic completeness of the target speech information based on the state information and the contextual information comprises:
determining at least one piece of candidate state information corresponding to the state information, wherein each candidate state information is related to a next action of the state information;
obtaining at least one first control instruction of each candidate state information, and obtaining a first semantic similarity degree between the target speech information and each first control instruction;
obtaining at least one second control instruction corresponding to the contextual information, and obtaining a second semantic similarity degree between the target speech information and each second control instruction; and
obtaining the semantic completeness of the target speech information based on the first semantic similarity degree and the second semantic similarity degree.

3. The method of claim 2, wherein obtaining the semantic completeness of the target speech information based on the first semantic similarity degree and the second semantic similarity degree comprises:
obtaining a first target control instruction that the first semantic similarity degree of the first target control instruction is greater than a first threshold;
obtaining a second target control instruction that the second semantic similarity degree of the second target control instruction is greater than a second threshold; and
obtaining the semantic completeness based on a semantic similarity between the first target control instruction and the second target control instruction.

4. The method of claim 3, further comprising:
obtaining a first difference between the first threshold and the first semantic similarity degree, based on no first control instruction being acquired and the second control instruction being acquired;
obtaining a first ratio of the first difference to the first threshold; and
obtaining the semantic completeness based on a first product value of the second semantic similarity degree and the first ratio.

5. The method of claim 3, further comprising:
obtaining a second difference between the second threshold and the second semantic similarity degree, based on no second control instruction being acquired and the first control instruction being acquired;
obtaining a second ratio of the second difference to the second threshold; and
obtaining the semantic completeness based on a second product value of the first semantic similarity degree and the second ratio.

6. The method of claim 3, further comprising:
obtaining a third difference between the first semantic similarity degree and the second semantic similarity degree, based on no second control instruction being acquired and no first control instruction being acquired; and
obtaining the semantic completeness based on an absolute value of the third difference.

7. The method of claim 1, wherein obtaining the semantic completeness of the target speech information based on the state information and the contextual information comprises:
obtaining a first characteristic value of the state information;
obtaining a second characteristic value of the contextual information;
obtaining a third characteristic value of the target speech information; and
obtaining the semantic completeness by inputting the first characteristic value, the second characteristic value, and the third characteristic value into a preset deep learning model;
wherein, the preset deep learning model learns in advance a preset correspondence between the first characteristic value, the second characteristic value, the third characteristic value, and the semantic completeness.

8. The method of claim 1, further comprising:
extracting voiceprint feature information of the target speech information;
determining user portrait information based on the voiceprint feature information;
determining whether the user portrait information belongs to preset user portrait information;
determining an adjustment duration corresponding to target user portrait information of the preset user portrait information based on determining that the user portrait information belongs to the target user portrait information; and
obtaining a sum of the monitoring duration and the adjustment duration, and updating the monitoring duration based on the sum.

9. The method of claim 1, wherein determining the monitoring duration based on the semantic completeness, comprises:
obtaining the monitoring duration based on the semantic completeness by querying a preset correspondence.

10. An electronic device, comprising:
at least one processor; and
a memory communicatively connected with the at least one processor; wherein,
the memory stores instructions executable by the at least one processor, and when the instructions are executed by the at least one processor, the at least one processor is configured to:
obtain state information of an application corresponding to target speech information and contextual information, based on obtaining the target speech information;
obtain a semantic completeness of the target speech information based on the state information and the contextual information;
determine a monitoring duration corresponding to the semantic completeness, and monitor whether there is speech information within the monitoring duration; and
perform speech recognition on the target speech information based on no speech information being monitored within the monitoring duration.

11. The electronic device of claim 10, wherein the processor is further configured to
determine at least one piece of candidate state information corresponding to the state information, wherein each candidate state information is related to a next action of the state information;
obtain at least one first control instruction of each candidate state information, and obtain a first semantic similarity degree between the target speech information and each first control instruction;
obtain at least one second control instruction corresponding to the contextual information, and obtain a second semantic similarity degree between the target speech information and each second control instruction; and
obtain the semantic completeness of the target speech information based on the first semantic similarity degree and the second semantic similarity degree.

12. The electronic device of claim 11, wherein the processor is further configured to:
obtain a first target control instruction that the first semantic similarity degree of the first target control instruction is greater than a first threshold;
obtain a second target control instruction that the second semantic similarity degree of the second target control instruction is greater than a second threshold; and
obtain the semantic completeness based on a semantic similarity between the first target control instruction and the second target control instruction.

13. The electronic device of claim 12, wherein the processor is further configured to:
obtain a first difference between the first threshold and the first semantic similarity degree, based on no first control instruction being acquired and the second control instruction being acquired;
obtain a first ratio of the first difference to the first threshold; and
obtain the semantic completeness based on a first product value of the second semantic similarity degree and the first ratio.

14. The electronic device of claim 12, wherein the processor is further configured to:
obtain a second difference between the second threshold and the second semantic similarity degree, based on no second control instruction being acquired and the first control instruction being acquired;
obtain a second ratio of the second difference to the second threshold; and
obtain the semantic completeness based on a second product value of the first semantic similarity degree and the second ratio.

15. The electronic device of claim 12, wherein the processor is further configured to:
obtain a third difference between the first semantic similarity degree and the second semantic similarity degree, based on no second control instruction being acquired and no first control instruction being acquired; and
obtain the semantic completeness based on an absolute value of the third difference.

16. The electronic device of claim 10, wherein the processor is further configured to:
obtain a first characteristic value of the state information;
obtain a second characteristic value of the contextual information;
obtain a third characteristic value of the target speech information; and
obtain the semantic completeness by inputting the first characteristic value, the second characteristic value, and the third characteristic value into a preset deep learning model;
wherein, the preset deep learning model learns in advance a preset correspondence between the first characteristic value, the second characteristic value, the third characteristic value, and the semantic completeness.

17. The electronic device of claim 10, wherein the processor is further configured to:
extract voiceprint feature information of the target speech information;
determine user portrait information based on the voiceprint feature information;
determine whether the user portrait information belongs to preset user portrait information;
determine an adjustment duration corresponding to target user portrait information of the preset user portrait information based on determining that the user portrait information belongs to the target user portrait information; and
obtain a sum of the monitoring duration and the adjustment duration, and update the monitoring duration based on the sum.

18. The electronic device of claim 10, wherein the processor is further configured to:
obtain the monitoring duration based on the semantic completeness by querying a preset correspondence.

19. A non-transitory computer-readable storage medium storing computer instructions, wherein the computer instructions are configured to cause the computer implement the method for recognizing a speech, the method comprising:
obtaining state information of an application corresponding to target speech information and contextual information, based on obtaining the target speech information;
obtaining a semantic completeness of the target speech information based on the state information and the contextual information;
determining a monitoring duration corresponding to the semantic completeness, and monitoring whether there is speech information within the monitoring duration; and
performing speech recognition on the target speech information based on no speech information being monitored within the monitoring duration.

20. The non-transitory computer-readable storage medium of claim 19, wherein obtaining the semantic completeness of the target speech information based on the state information and the contextual information comprises:
determining at least one piece of candidate state information corresponding to the state information, wherein each candidate state information is related to a next action of the state information;
obtaining at least one first control instruction of each candidate state information, and obtaining a first semantic similarity degree between the target speech information and each first control instruction;
obtaining at least one second control instruction corresponding to the contextual information, and obtaining a second semantic similarity degree between the target speech information and each second control instruction; and
obtaining the semantic completeness of the target speech information based on the first semantic similarity degree and the second semantic similarity degree.
